(19) United States
(12) Patent Application Publication
(10) Pub. No.: US 2025/0061825 A1
(43) Pub. Date: Feb. 20, 2025

(54) LIGHT BOX

(71) Applicant: Shuai WANG, Qingdao City (CN)

(72) Inventor: Shuai WANG, Qingdao City (CN)

(21) Appl. No.: 18/939,556

(22) Filed: Nov. 7, 2024

(51) Int. Cl. G09F 13/04; G09F 13/06

(52) U.S. Cl. CPC G09F 13/049; G09F 13/0413; G09F 13/06

(57) ABSTRACT

A light box includes an accommodating housing, presentation panel, a bottom plate and a decorative light strip. The accommodating housing is provided with a presentation panel, an accommodating chamber, and an opening communicated to the accommodating chamber. The presentation panel includes a preset hollow region and a clamping hole. The bottom plate is covered at the opening. The bottom plate includes a bottom plate inner side and a bottom plate outer side corresponding to the bottom plate inner side. The bottom plate inner side is opposite to the opening. The bottom plate light strip is arranged on the bottom plate inner side to illuminate the accommodating chamber. The decorative light strip is provided with a lamp bead assembly. The lamp bead assembly penetrates through the presentation panel through the clamping hole from the accommodating chamber, and is fixedly connected to the presentation panel.

### TECHNICAL FIELD

The present disclosure relates to the technical field of presentation devices, and in particular, to a light box.

### BACKGROUND OF THE INVENTION

Light boxes, as an economical, efficient, and safe presentation device, have always been paid attention to. At present, the light boxes on the market, as presentation devices for commercial advertisement, can be mounted at prominent positions in business places such as shops, restaurants, hotels, and cinemas, and attract the attention of passersby with their bright lighting and unique pattern designs, thereby guiding customers into the shops for consumption. At night, advertising light boxes can illuminate streets, color the city, and create a lively and bustling commercial atmosphere.

At present, although the light boxes on the market have achieved the goal of attracting the attention of the passerby with their bright lighting and unique pattern designs, there are still problems of single lighting color and lack of hierarchy of light, which causes poor visual effects of the light boxes.

Therefore, the present disclosure provides a light box that can effectively solve the above-mentioned problems.

### SUMMARY OF THE INVENTION

To overcome the shortcomings in the prior art, the present disclosure provides a light box which has a simple structure and can further solve the problems of single lighting color and lack of hierarchy of light of an advertising light box. The light box effectively ensures the user experience, and the visual presentation effect achieved by the light box is further enhanced.

The technical solution adopted by the present disclosure to solve the technical problem is as follows.

A light box, includes:
an accommodating housing, wherein the accommodating housing is provided with a presentation panel, an accommodating chamber, and an opening communicated to the accommodating chamber, wherein the presentation panel includes a preset hollow region and a clamping hole, and the preset hollow region is in a shape of a selected character;
a bottom plate, wherein the bottom plate is covered at the opening; the bottom plate includes a bottom plate inner side and a bottom plate outer side corresponding to the bottom plate inner side; the bottom plate inner side is opposite to the opening;
a bottom plate light strip, wherein the bottom plate light strip is arranged on the bottom plate inner side to illuminate the accommodating chamber; and
a decorative light strip, wherein the decorative light strip is provided with a lamp bead assembly; and the lamp bead assembly penetrates through the presentation panel through the clamping hole from the accommodating chamber, and is fixedly connected to the presentation panel.

As an improvement of the present disclosure, the presentation panel is further provided with a hollow wireframe; and the hollow wireframe is arranged around the preset hollow region.

As an improvement of the present disclosure, the lamp bead assembly is provided with a base, a hemispherical housing, a light-emitting diode (LED) wick, and a control chip; the base is fixedly connected to the hemispherical housing; the base and the hemispherical housing jointly define a lamp bead space; the LED wick and the control chip are arranged in the lamp bead space; and the control chip is configured to control a lighting change of the LED wick.

As an improvement of the present disclosure, the base is provided with a clamping convex block; and the clamping convex block is in clamping connection to the clamping hole, so that the lamp bead assembly is connected to the presentation panel.

As an improvement of the present disclosure, a junction of the clamping connection between the clamping convex block and the clamping hole is sealed with glue.

As an improvement of the present disclosure, the light-transmittance plate is arranged in the accommodating chamber and abuts against the presentation panel; and the light-transmittance plate covers the preset hollow region.

As an improvement of the present disclosure, the accommodating housing is further provided with a mounting hole; and the mounting hole is gourd-shaped.

As an improvement of the present disclosure, the accommodating housing is further provided with a drain hole communicated to the accommodating chamber; and the drain hole is located in a bottom of the accommodating housing.

As an improvement of the present disclosure, a black coating layer is arranged on an outer surface of the accommodating housing; and the black coating layer is configured to reduce a light reflectivity of the outer surface of the accommodating housing.

As an improvement of the present disclosure, the accommodating housing is made of a metal material, and the black coating layer is a metal baking paint.

As an improvement of the present disclosure, the metal material is a stainless steel plate.

As an improvement of the present disclosure, the bottom plate and the accommodating housing are fixedly connected to close the opening.

As an improvement of the present disclosure, the light-transmittance plate is an acrylic plate.

As an improvement of the present disclosure, the bottom plate is a black polyvinyl chloride (PVC) plate.

The present disclosure further provides a method for making a light box, includes:
S10: measuring and scribing a metal plate;
S20: hollowing and bending the metal plate according the scribing;
S30: mounting a light-transmittance plate;
S40: mounting a decorative light strip;
S50: mounting a bottom plate light strip on a bottom plate; and
S60: mounting the bottom plate.

As an improvement of the present disclosure, step S20 includes:
S21: cutting a leftover material of the metal plate;
S22: performing hollowing according to scribed shapes of a preset clamping hole, a preset character shape, and a preset wireframe;
S23: for a scribed line with a preset bend, first performing dadoing, forming a V-shaped opening by cutting, performing flanging bending, and welding a connected edge after the flanging bending, thus forming an accommodating housing; and
S24: grinding an outer surface of the accommodating housing, and performing baking paint treatment.

As an improvement of the present disclosure, step S24 of performing baking paint treatment includes:
S24a: performing preliminary baking paint treatment; and
S24b: performing secondary baking paint treatment.

As an improvement of the present disclosure, step S30 includes:
S31: fixedly connecting the light-transmittance plate to the accommodating housing; and
S32: sealing the light-transmittance plate and the accommodating housing with glue.

As an improvement of the present disclosure, step S40 includes:
S41: fixedly connecting the decorative light strip to the accommodating chamber; and
S42: sealing the decorative light strip and the accommodating housing with glue.

As an improvement of the present disclosure, step S60 includes:
S61: fixedly connecting the bottom plate to the accommodating housing; and
S62: sealing the bottom plate and the accommodating housing with glue.

Beneficial effects: Through the arrangement of the above structure, during use, the presentation panel includes the preset hollow region and the clamping hole. The preset hollow region is in the shape of the selected character, so the light box can present specific character or pattern according to a need. Since the decorative light strip is provided with the lamp bead assembly, the lamp bead assembly passes through the presentation panel through the clamping hole from the accommodating chamber. The lamp bead assembly is fixedly connected to the presentation panel, and the clamping hole is configured to allow the lamp bead assembly to partially pass through the presentation panel. The use of the decorative light strip makes the advertising light box more beautiful, thereby increasing the attractiveness and recognition of the advertising light box. Since the bottom plate light strip is arranged on the bottom plate inner side to illuminate the accommodating chamber, so that light can be clearly seen even at night or in a low light environment according to the shape of the preset hollow region of the advertising light box. The bottom plate light strip can emit high-brightness normally-on light having a color that highlights the character shape corresponding to the preset hollow region. The decorative light strip can emit light with changing color or low- and medium-brightness normally-on light having a color, making the light box have rich lighting colors. It is layered and highlighted, which further improves a visual presentation effect of the light box and effectively ensures a user experience.

### BRIEF DESCRIPTION OF DRAWINGS

In order to explain the technical solutions of the embodiments of the present disclosure more clearly, the following will briefly introduce the accompanying drawings used in the embodiments. The drawings in the following description are only some embodiments of the present disclosure. Those of ordinary skill in the art can obtain other drawings based on these drawings without creative work. In addition, the accompanying drawings are not drawn to a scale of 1:1, and the relative dimensions of the various elements are only shown as examples in the diagrams, not necessarily drawn to a true scale.

The present disclosure is further described below in detail in combination with the accompanying drawings and embodiments.

FIG. 1 is a schematic diagram of an entire structure of a light box provided by the present disclosure, viewed from one visual angle;

FIG. 2 is a schematic diagram of an entire structure of a light box provided by the present disclosure, viewed from another visual angle;

FIG. 3 is an exploded diagram of a light box provided by the present disclosure, viewed from one visual angle;

FIG. 4 is an exploded diagram of a light box provided by the present disclosure, viewed from another visual angle;

FIG. 5 is a schematic diagram of preparing to make a metal plate of an accommodating housing 100 of a light box after scribing;

FIG. 6 is a schematic diagram of preparing to make a metal plate of an accommodating housing 100 of a light box after scribing and removal of excess materials;

FIG. 7 is an enlarged diagram of an entire structure of a lamp bead assembly 410 of a light box provided by the present disclosure;

FIG. 8 is an exploded diagram of a lamp bead assembly 410 of a light box provided by the present disclosure;

FIG. 9 is a flowchart of overall steps of a method provided by the present disclosure;

FIG. 10 is a detailed flowchart of step S20 of a method provided by the present disclosure;

FIG. 11 is a detailed flowchart of step S24 of a method provided by the present disclosure;

FIG. 12 is a detailed flowchart of step S30 of a method provided by the present disclosure;

FIG. 13 is a detailed flowchart of step S40 of a method provided by the present disclosure;

FIG. 14 is a detailed flowchart of step 60 of a method provided by the present disclosure.

### DETAILED DESCRIPTION OF THE INVENTION

To make the aforementioned objectives, features, and advantages of the present disclosure more comprehensible, specific implementations of the present disclosure are described in detail below in conjunction with the accompanying drawings. In the following description, numerous specific details are set forth to provide a thorough understanding of the present disclosure. The present disclosure may, however, be embodied in many forms different from that described here. A person skilled in the art can make similar improvements without departing from the connotation of the present disclosure. Therefore, the present disclosure is not limited by the specific embodiments disclosed below.

In the description of the present disclosure, It is to be understood that, The terms “center”, “longitudinal”, “transverse”, “upper”, “lower”, “front”, “rear”, “left”, “right”, “vertical”, “horizontal”, “top”, “bottom”, “inner”, “outer”, “clockwise”, “counterclockwise”, and the like indicate azimuth or positional relationships based on the azimuth or positional relationships shown in the drawings, For purposes of convenience only of describing the present disclosure and simplifying the description, Rather than indicating or implying that the indicated device or element must have a particular orientation, be constructed and operated in a particular orientation, therefore, not to be construed as limiting the present disclosure.

In addition, the terms “first” and “second” are used for descriptive purposes only, while not to be construed as indicating or implying relative importance or implicitly specifying the number of technical features indicated thereby, features defining “first,” “second,” and “second” may explicitly or implicitly include one or more of the described features. In the description of the present disclosure, “multiple” means two or more unless explicitly specified otherwise.

In addition, the terms “install”, “arrange”, “provide”, “connect” and “couple” should be understood broadly. For example, it can be a fixed connection, a detachable connection, an integral structure, a mechanical connection, an electrical connection, a direct connection, an indirect connection through an intermediate medium, or a communication between two devices, elements or components. For ordinary technical personnel in this field, the specific meanings of the above terms in present disclosure can be understood based on specific circumstances.

In the present disclosure, unless specific regulation and limitation otherwise, the first feature “onto” or “under” the second feature may include the direct contact of the first feature and the second feature, or may include the contact of the first feature and the second feature through other features between them instead of direct contact. Moreover, the first feature “onto”, “above” and “on” the second feature includes that the first feature is right above and obliquely above the second feature, or merely indicates that the horizontal height of the first feature is higher than the second feature. The first feature “under”, “below” and “down” the second feature includes that the first feature is right above and obliquely above the second feature, or merely indicates that the horizontal height of the first feature is less than the second feature.

It should be noted that when an element is referred to as being “fixed to” another element, the element can be directly on another component or there can be a centered element. When an element is considered to be “connected” to another element, the element can be directly connected to another element or there may be a centered element. The terms “inner”, “outer”, “left”, “right”, and similar expressions used herein are for illustrative purposes only and do not necessarily represent the only implementation.

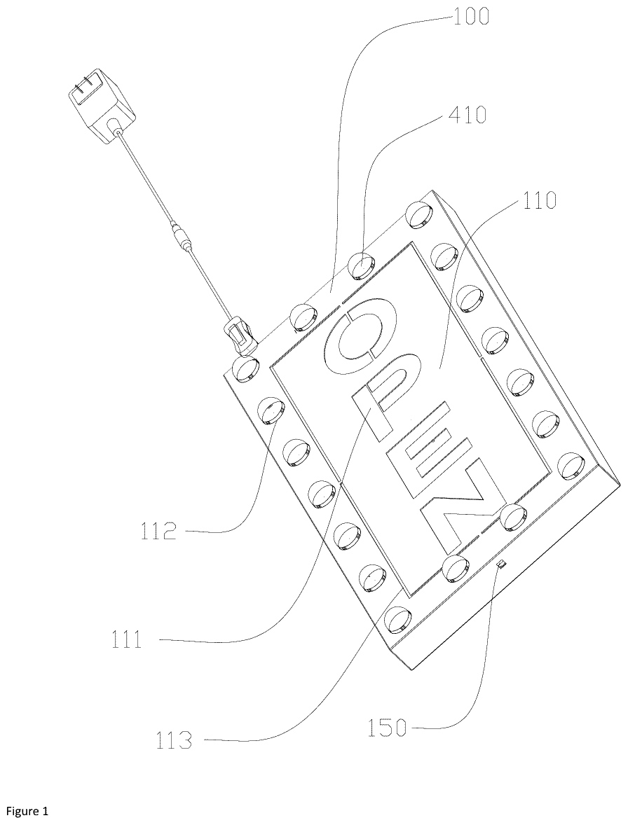

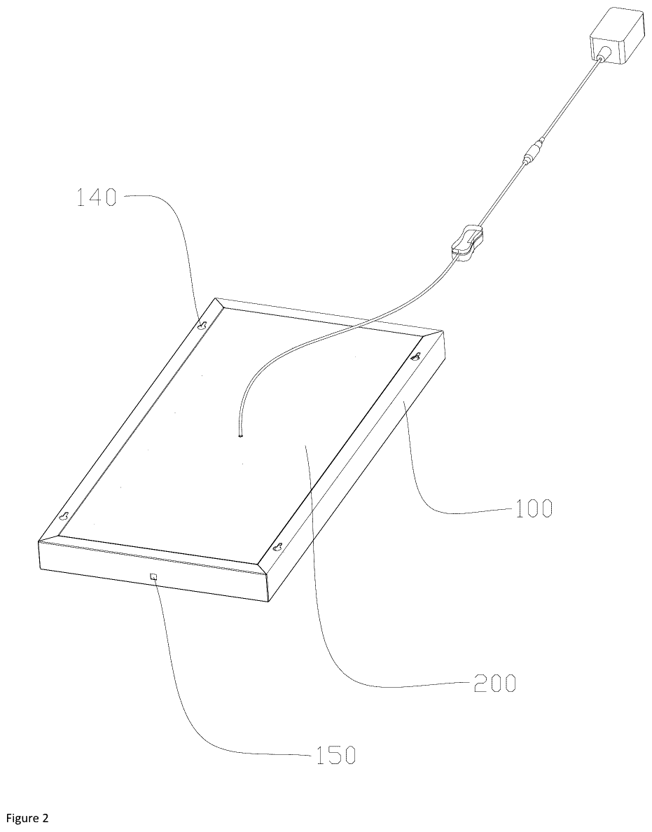

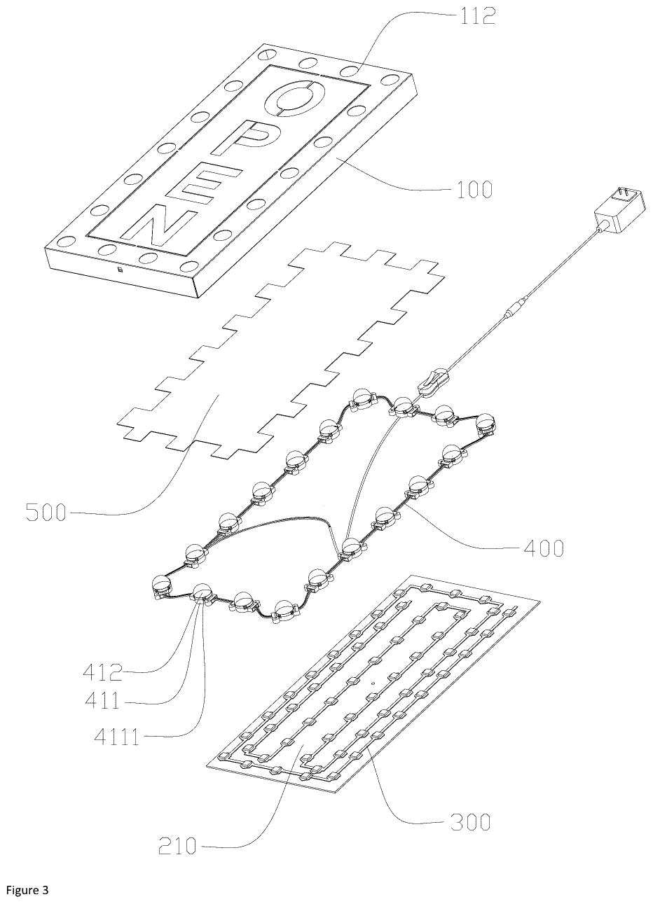

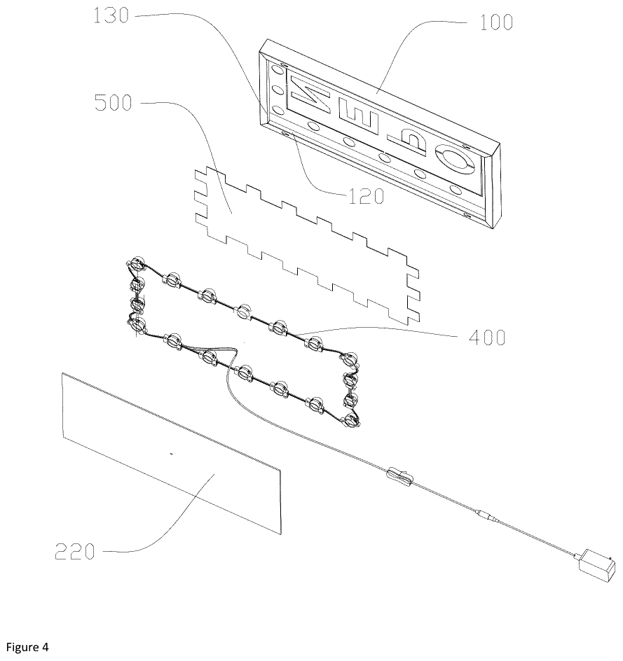

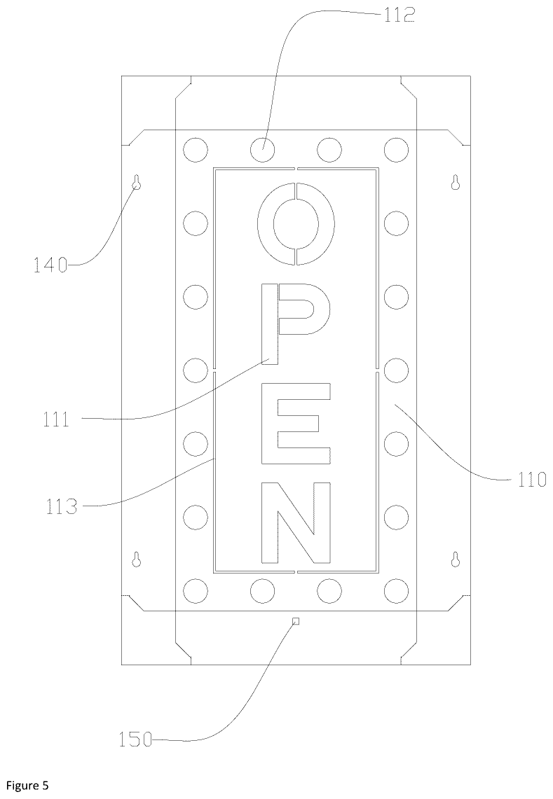

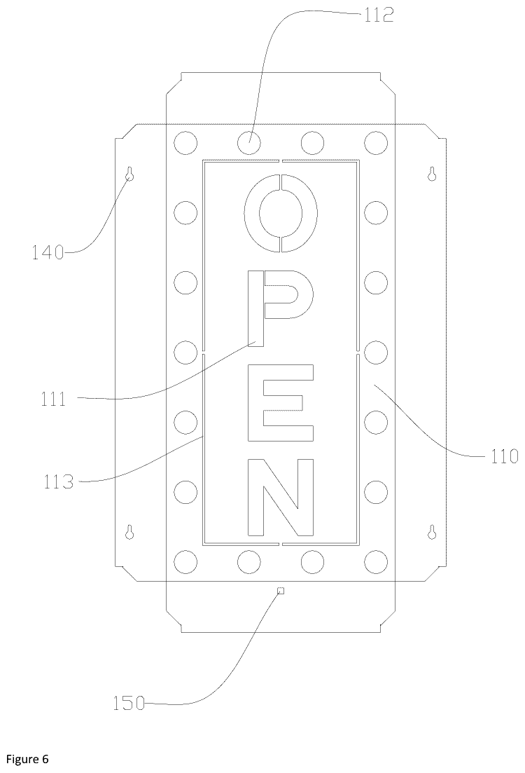

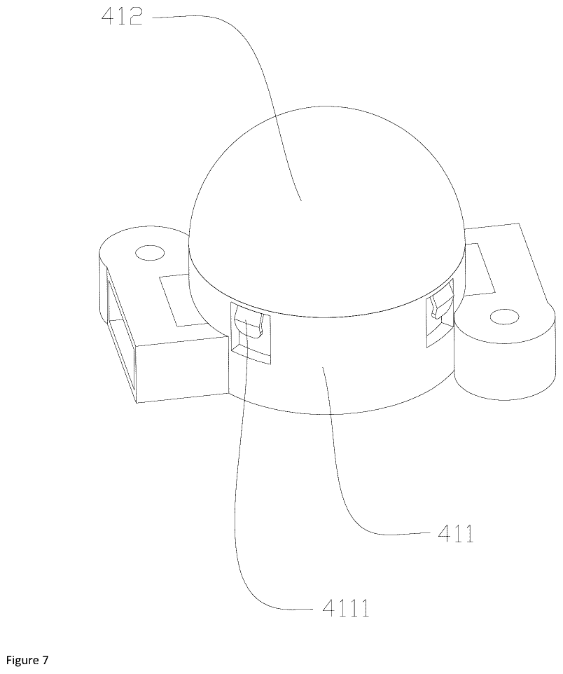

Referring to FIG. 1 to FIG. 8, a light box includes:
an accommodating housing 100, wherein the accommodating housing 100 is provided with a presentation panel 110, an accommodating chamber 120, and an opening 130 communicated to the accommodating chamber 120, wherein the presentation panel 110 includes a preset hollow region 111 and a clamping hole 112, and the preset hollow region 111 is in a shape of a selected character;
a bottom plate 200, wherein the bottom plate 200 is covered at the opening 130; the bottom plate 200 includes a bottom plate inner side 210 and a bottom plate outer side 220 corresponding to the bottom plate inner side 210; the bottom plate inner side 210 is opposite to the opening 130;
a bottom plate light strip 300, wherein the bottom plate light strip 300 is arranged on the bottom plate inner side 210 to illuminate the accommodating chamber 120; and
a decorative light strip 400, wherein the decorative light strip 400 is provided with a lamp bead assembly 410; and the lamp bead assembly 410 penetrates through the presentation panel 110 through the clamping hole 112 from the accommodating chamber 120, and is fixedly connected to the presentation panel 110.

Through the arrangement of the above structure, during use, the presentation panel 110 includes the preset hollow region 111 and the clamping hole 112. The preset hollow region 111 is in the shape of the selected character, so the light box can present specific character or pattern according to a need. Since the decorative light strip 400 is provided with the lamp bead assembly 410, the lamp bead assembly 410 passes through the presentation panel 110 through the clamping hole 112 from the accommodating chamber 120. The lamp bead assembly 410 is fixedly connected to the presentation panel 110, and the clamping hole 112 is configured to allow the lamp bead assembly 410 to partially pass through the presentation panel 110. The use of the decorative light strip 400 makes the advertising light box more beautiful, thereby increasing the attractiveness and recognition of the advertising light box. Since the bottom plate light strip 300 is arranged on the bottom plate inner side 210 to illuminate the accommodating chamber 120, so that light can be clearly seen even at night or in a low light environment according to the shape of the preset hollow region 111 of the advertising light box. The bottom plate light strip 300 can emit high-brightness normally-on light having a color that highlights the character shape corresponding to the preset hollow region 111. The decorative light strip 400 can emit light with changing color or low- and medium-brightness normally-on light having a color, making the light box have rich lighting colors. It is layered and highlighted, which further improves a visual presentation effect of the light box and effectively ensures a user experience.

In this embodiment, the presentation panel 110 is further provided with a hollow wireframe 113; and the hollow wireframe 113 is arranged around the preset hollow region 111. Through the arrangement of the above structure, during use, this design allows the advertising light box to present a specific character or pattern and achieve a unique visual effect. Due to the presence of the hollow wireframe 113, the advertising light box can create a three-dimensional light and shadow effect through the illumination of the bottom plate light strip at night or in a low-light environment. This light and shadow effect not only increases the attractiveness of the advertising light box, but also makes the advertising light box stand out among numerous advertisements and attract the attention of customers. In addition, the design of the hollow wireframe 113 can be customized according to different needs, such as selecting different colors, shapes, and sizes to meet different advertising needs. Due to the design flexibility, the advertising light box can meet needs of different merchants to improve the applicability of the advertising light box.

In this embodiment, the lamp bead assembly 410 is provided with a base 411, a hemispherical housing 412, an LED wick 413, and a control chip 414. The base 411 is fixedly connected to the hemispherical housing 412. The base 411 and the hemispherical housing 412 jointly define a lamp bead space 415. The LED wick 413 and the control chip 414 are arranged in the lamp bead space 415. The control chip 414 is configured to control a lighting change of the LED wick 413. Through the arrangement of the above structure, during use, the base 411 is a bottom of the lamp bead assembly 410, made of plastic, and has a strength and a stability. To design the base 411, a manner for fixed connection with the presentation panel needs to be considered to ensure that the lamp bead assembly can be firmly mounted on the presentation panel. The hemispherical housing 412 is a top of the lamp bead assembly 410, made of transparent plastic, and formed into a hemispherical cover. To design the hemispherical housing 412, an effect of light transmittance needs to be considered to ensure that light emitted by the LED wick can fully penetrate through the hemispherical housing 412. The LED wick 413 is a core part of the lamp bead assembly, and is responsible for emitting light. The LED wick is composed of a plurality of LED chips and has the characteristics of low and medium brightness, low energy consumption, and long lifespan. To select the LED wick, a color, a brightness, and an angle of light need to be considered to meet illumination and decoration needs of the advertising light box. The control chip 414 is a control part of the lamp bead assembly, and is responsible for controlling the light change of the LED wick. The control chip can be programmed to achieve various lighting effects, such as flickering, gradient changing, and breathing. The lamp bead space 415 is a space jointly defined by the base 411 and the hemispherical housing 412, and is configured to accommodate the LED wick 413 and the control chip 414. To design the lamp bead space, requirements for heat dissipation and dust prevention need to be considered to ensure that the lamp bead assembly can work stably and reliably.

In this embodiment, the base 411 is provided with a clamping convex block 4111; and the clamping convex block 4111 is in clamping connection to the clamping hole 112, so that the lamp bead assembly 410 is connected to the presentation panel 110. Through the arrangement of the above structure, during use, the lamp bead assembly 410 is in clamping connection to the presentation panel 110 through the clamping convex block 4111 and the clamping hole 112. This connection mode ensures a stable connection between the lamp bead assembly and the presentation panel. The clamping convex block 4111 is a protruding part designed on the base 411, which has an elasticity and a strength. To design the clamping convex block 4111, the degree of matching with the clamping hole 112 needs to be considered to ensure that they can be tightly clamped together. The clamping hole 112 is a hole designed on the presentation panel 110 to match the clamping convex block 4111. To design the clamping hole 112, size and shape matching with the clamping convex block 4111 needs to be considered to ensure that they can be firmly clamped together. When the lamp bead assembly 410 needs to be mounted on the presentation panel 110, an operator only needs to align the base 411 of the lamp bead assembly with the clamping hole 112 on the presentation panel, and then insert the lamp bead assembly into the presentation panel. During the insertion, the clamping convex block 4111 will cooperate with the clamping hole 112 to achieve a clamping effect to enable the lamp bead assembly to be tightly combined with the presentation panel.

In this embodiment, a junction of the clamping connection between the clamping convex block 4111 and the clamping hole 112 is sealed with glue. To further ensure the stable connection between the lamp bead assembly 410 and the presentation panel 110, and improve the waterproof and dustproof performance, the junction of the clamping connection between the clamping convex block 4111 and the clamping hole 112 is sealed with the glue. By applying the glue to the junction, moisture, dust, and other impurities can be effectively prevented from entering the lamp bead assembly 410 and the presentation panel 110, thereby protecting internal elements from being damaged. Meanwhile, glue sealing can enhance a stability of the clamping connection, prevent the lamp bead assembly from being loosened under vibration or an external force, prolong a service life of the lamp bead assembly, and improve a stability of the lamp bead assembly.

In this embodiment, the light box further includes a light-transmittance plate 500. The light-transmittance plate 500 is arranged in the accommodating chamber 120 and abuts against the presentation panel 110. The light-transmittance plate 500 covers the preset hollow region 111. The light-transmittance plate 500 is an important part in the design, which is cleverly arranged in the accommodating chamber 120. The light-transmittance plate 500 closely abuts against the presentation panel 110 through a fixed connection. This fixed connection ensures that the light-transmittance plate 500 remains stable on the presentation panel 110 and will not move or fall off due to an external force. A main function of the light-transmittance plate 500 is to cover the preset hollow region 111, so that an image or text on the presentation panel 110 can be presented through a light-transmittance property of the light-transmittance plate 500. Due to the presence of the light-transmittance plate 500, light passes through the preset hollow region 111 more uniformly, achieving a more prominent presentation effect. The image or text is clearly visible, and the sense of hierarchy and three-dimensionality of presentation are also enhanced.

In this embodiment, the accommodating housing 100 is further provided with a mounting hole 140. The mounting hole 140 is gourd-shaped. Through the arrangement of the above structure, during use, because of the unique gourd shape, the mounting hole 140 can better adapt to mounting parts with different shapes and sizes. The gourd-shaped mounting hole 140 has a large opening diameter, which facilitates insertion of a mounting part. Meanwhile, as a hole diameter gradually decreases, the mounting hole 140 can provide better fixation and supporting for a mounting part, thereby ensuring a stability of the mounting part inside the accommodating housing 100.

In this embodiment, the accommodating housing 100 is further provided with a drain hole 150 communicated to the accommodating chamber 120. The drain hole 150 is located in a bottom of the accommodating housing 100. To ensure dryness and cleanliness of an internal environment of the accommodating housing 100, the drain hole 150 is provided in the bottom of the accommodating housing 100. The drain hole 150 is designed at the lowest point of the accommodating housing 100, so that regardless of the reason of water accumulated inside the housing, the water can be effectively discharged through the drain hole 150 to prevent occurrence of water accumulation. In addition, the size of the drain hole 150 has been accurately calculated to ensure the drainage efficiency without affecting the overall structural strength of the accommodating housing 100 due to a large hole diameter.

In this embodiment, a black coating layer is arranged on an outer surface of the accommodating housing 100. The black coating layer is configured to reduce a light reflectivity of the outer surface of the accommodating housing 100. Through the arrangement of the above structure, during use, this black coating layer not only gives the accommodating housing 100 an elegant appearance, but more importantly, the black coating layer has a function of reducing the light reflectivity, so that the accommodating housing 100 is relatively dark, which has a sharp contrast with the brightness of the preset hollow region 111 and highlights the character shape of the preset hollow region 111. In addition, the black coating layer further has an excellent weather resistance and an excellent wear resistance, which can protect the accommodating housing 100 from being damaged by ultraviolet radiation, chemical substances, and physical wear. This coating layer not only enhances a durability of the accommodating housing 100, but also reduces a frequency of maintenance and replacement, thereby reducing a long-term use cost.

In this embodiment, the accommodating housing 100 is made of a metal material, and the black coating layer is a metal baking paint. The accommodating housing 100 is made of a high-performance metal material. This material is selected based on its excellent mechanical property, electromagnetic shielding ability, and environmental adaptability. The metal material undergoes strict quality control to ensure that the metal material can achieve an expected mechanical strength and durability during production. In addition, to select the metal material, a stability of the metal material under different environmental conditions is further considered, including a temperature change, a humidity change, chemical corrosion, and the like. The black coating layer is the metal baking paint, which is a high-performance coating that is particularly suitable for coating a metal surface. The metal baking paint has an excellent adhesion and durability, and can form a firm protective layer on the metal surface.

In this embodiment, the metal material is a stainless steel plate. The metal material is specifically the stainless steel plate. Stainless steel is alloy steel containing a proportion of chromium, so that the stainless steel has an excellent corrosion resistance. The stainless steel plate is selected based on its comprehensive advantages in mechanical strength, corrosion resistance, wear resistance, and attractive appearance. The metal material is the stainless steel plate. The selection of this material not only improves the mechanical performance and the corrosion resistance of the accommodating housing 100, but also enhances the wear resistance and the attractive appearance. Because of a high-performance characteristic, the stainless steel plate becomes an ideal choice for the accommodating housing 100, ensuring a long-term stability and reliability of the stainless steel plate in various environments.

In this embodiment, the bottom plate 200 and the accommodating housing 100 are fixedly connected to close the opening 130. Through the arrangement of the above structure, this fixed connection ensures an integrity and a sealing property of the accommodating housing 100 during use.

In this embodiment, the light-transmittance plate 500 is an acrylic plate. The acrylic plate has an excellent light-transmittance performance, weather resistance, and mechanical strength. It is an ideal light-transmittance plate material. The light transmittance of the acrylic plate can reach 92% or above, and can provide a clear and bright visual effect. It is very suitable for being used as a material of the light-transmittance plate 500. By selecting the appropriate acrylic plate, a long-term stability and reliability of the light-transmittance plate 500 can be ensured in various environments, and light-transmittance and decoration needs are met.

In this embodiment, the bottom plate 200 is a black PVC plate. The bottom plate 200 is the black PVC plate. The black PVC plate has an excellent chemical stability, corrosion resistance, and mechanical strength, so that it is an ideal bottom plate material. By selecting the appropriate black PVC plate, a long-term stability and reliability of the bottom plate 200 can be ensured in various environments, and structure and appearance needs are met.

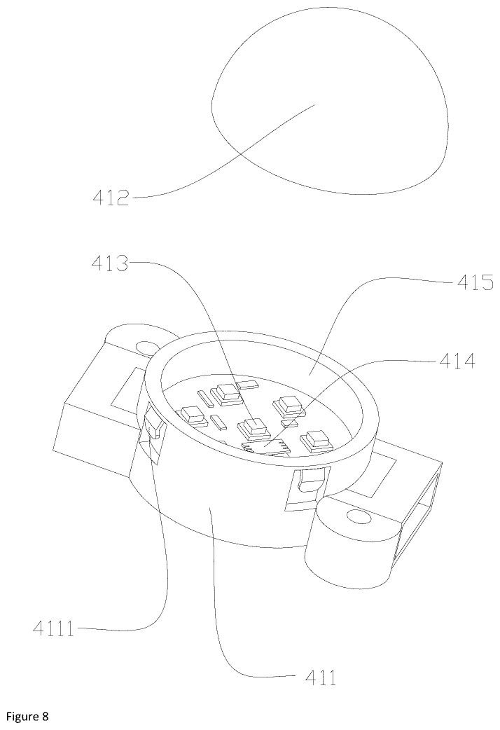

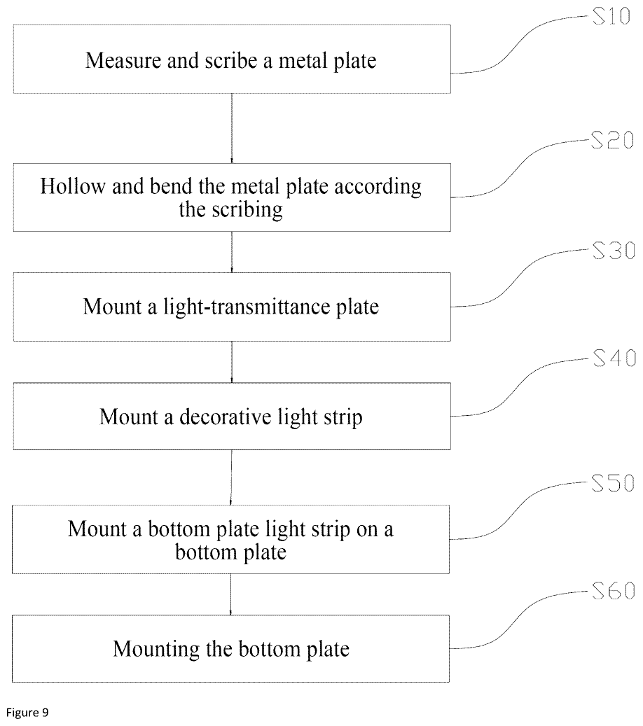

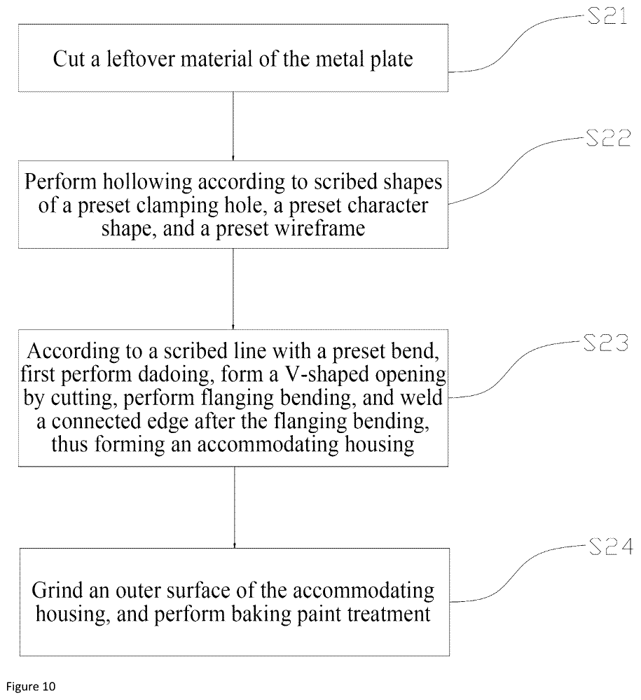

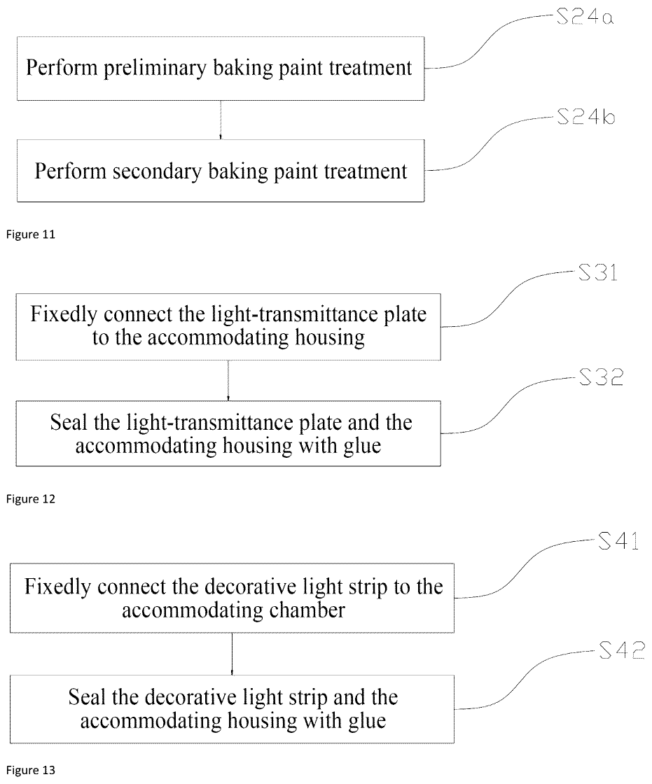

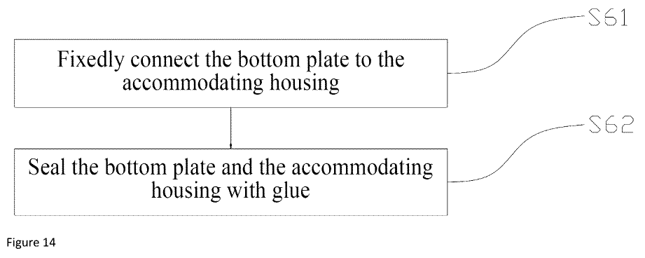

Referring to FIG. 9 to FIG. 14, a method for making a light box includes the following steps:
S10: measuring and scribing a metal plate. First, the metal plate is precisely measured and scribed according to a design drawing of the light box. During scribing, a size, a shape, and a part needing to be hollowed of the light box need to be considered. Measurement and scribing are key steps that ensures the manufacturing precision of the light box.
S20: hollowing and bending the metal plate according to the scribing. An appropriate tool is used to hollow and bend the metal plate according to a measurement result and a scribing result. A hollowed part may be a character, a pattern, or another design element of the light box. A bent part forms a three-dimensional structure of the light box. This step requires a precise operation to ensure that the shape and structure of the light box meets design requirements.
S30: mounting a light-transmittance plate 500. The light-transmittance plate 500 is placed at the hollow part of the metal plate to ensure that the light-transmittance plate 500 closely abuts against an edge of the metal plate. Selection and a mounting position of the light-transmittance plate 500 need to be determined according to a design and functions of the light box to achieve the best light-transmittance effect.
S40: mounting a decorative light strip 400. The decorative light strip 400 is fixed at an appropriate position of the metal plate, usually at an edge of the light-transmittance plate or inside the light-transmittance plate. Selection and a mounting position of the decorative light strip 400 need to be determined according to a design and an illumination effect of the light box to enhance the visual effect of the light box.
S50: mounting a bottom plate light strip 300 on a bottom plate 200. The bottom plate light strip 300 is fixed at an appropriate position of the bottom plate 200, usually at an edge of the bottom plate or inside the bottom plate. Selection and a mounting position of the bottom plate light strip 300 need to be determined according to a design and an illumination effect of the light box to provide uniform bottom plate illumination.
S60: mounting the bottom plate 200. The bottom plate 200 is fixed at a bottom of the light box to ensure that the bottom plate 200 closely abuts against an edge of the metal plate. Selection and a mounting position of the bottom plate 200 need to be determined according to a design and a structure of the light box to provide stable supporting.

In summary, the method for making the light box in this embodiment includes: measuring and scribing the metal plate, hollowing and bending the metal plate according to the scribing, mounting the light-transmittance plate 500, mounting the decorative light strip 400, mounting the bottom plate light strip 300 on the bottom plate 200, and mounting the bottom plate 200. These steps ensure a making precision, a structural stability, and a visual effect of the light box.

In this embodiment, step S20 specifically includes the following steps:
S21: cutting a leftover material of the metal plate. Before making the light box, it is necessary to first cut the metal plate to remove unnecessary leftover materials. This step can be completed using a tool such as a shearing machine and a laser cutting machine to ensure that a size and a shape of the metal plate meet design requirements.
S22: performing hollowing according to scribed shapes of a preset clamping hole, a preset character shape, and a preset wireframe. According to the design drawing, the metal plate is scribed to obtain the clamping hole 112, the character shape, and the wireframe. Then, an appropriate tool (such as a punching machine and a laser cutting machine) is used to hollow the metal plate and form the desired shapes and the desired structures.
S23: according to a scribed line with a preset bend, first performing dadoing, forming a V-shaped opening by cutting, performing flanging bending, and welding a connected edge after the flanging bending, thus forming an accommodating housing 100. According to the design drawing, the metal plate is scribed to obtain a bend shape. Then, a dadoing machine is used to cut the bend to obtain the V-shaped opening for easy bending. Next, a bending machine is used to perform flanging bending on the metal plate to form the shape of the accommodating housing 100. Finally, a connecting edge that needs to be connected after the flanging bending is welded to ensure a structural stability of the accommodating housing 100.
S24: grinding an outer surface of the accommodating housing 100, and performing baking paint treatment. After the making of the accommodating housing 100 is completed, the outer surface of the accommodating housing needs to be ground to remove welding marks, scratches, and other defects, making the surface smooth. Then, the accommodating housing 100 is subjected to the baking paint treatment to improve its corrosion resistance, wear resistance, and attractive appearance. A color and a texture of the baking paint can be selected according to a design requirement.

In summary, step S20 in this embodiment includes: cutting the leftover material of the metal plate; performing hollowing according to the scribed shapes of the preset clamping hole 112, the preset character shape, and the preset wireframe; according to a scribed line with a preset bend, performing dadoing, forming a V-shaped opening by cutting, performing flanging bending, and welding a connected edge to form the accommodating housing 100; and performing grinding and baking paint treatment on the outer surface of the accommodating housing 100. These steps ensure a making precision, a structural stability, and a visual effect of the light box.

In this embodiment, the baking paint treatment in step S24 needs to be performed twice to ensure a final appearance quality and a durability of the light box. Specific steps are as follows:
S24a: performing preliminary baking paint treatment. After the outer surface of the accommodating housing 100 is ground, the preliminary baking paint treatment is first performed. A purpose of this step is to provide a basic protective layer for the accommodating housing 100 and prevent a metal surface from being in contact with moisture and oxygen in air, thereby reducing the possibility of oxidation and corrosion. A preliminary baking paint uses a corrosion-resistant primer which can fill small grooves and uneven places on the metal surface, to provide a smooth surface for a subsequent baking paint layer.
S24b: performing secondary baking paint treatment. After the preliminary baking paint layer is dried and cured, secondary baking paint treatment is performed. A purpose of this step is to provide a final color and texture for the light box and add an additional protective layer. The secondary baking paint selects a color and a glossiness which are matched with a design requirement to ensure the attractive appearance of the light box. In addition, the secondary baking paint can also improve the wear resistance of the light box, making it less susceptible to scratches and wear during long-term use.

Due to the twice baking paint treatment, the light box in this embodiment not only achieves a good appearance effect, but also improves its corrosion resistance and wear resistance, thereby prolonging the service life of the light box.

In this embodiment, step S30 specifically includes the following steps:
S31: fixedly connecting the light-transmittance plate 500 to the accommodating housing 100. Firstly, the light-transmittance plate 500 is placed at a designated position of the accommodating housing 100. The light-transmittance plate 500 is made of an acrylic plate to ensure that light can pass through the plate and illuminate the preset hollow region 111 on the light box. The fixed connection between the light-transmittance plate 500 and the accommodating housing 100 is achieved through an adhesive. A purpose of the fixed connection is to ensure that the light-transmittance plate 500 remains stable during use of the light box and will not move or fall off due to an external force.
S32: sealing the light-transmittance plate 500 and the accommodating housing 100 with glue. After the light-transmittance plate 500 is fixedly connected to the accommodating housing 100, glue sealing treatment needs to be performed in order to improve the overall sealing and waterproof performance. The glue sealing treatment can be performed on a joint between the light-transmittance plate 500 and the accommodating housing 100 to form a glue tape for sealing, which prevents moisture, dust, and other pollutants from entering the light box. The glue sealing treatment can also enhance the connection strength between the light-transmittance plate 500 and the accommodating housing 100, which further improves a durability of the light box.

By performing step S31 and step S32, the fixed connection and the sealing treatment between the light-transmittance plate 500 and the accommodating housing 100 ensure the overall structural stability and sealing property of the light box, thus providing a reliable guarantee for normal work and long-term use of the light box.

In this embodiment, step S40 specifically includes the following steps:
S41: fixedly connecting the decorative light strip 400 to the accommodating chamber 100. Firstly, the decorative light strip 400 is placed at a designated position of the accommodating housing 100. The decorative light strip 400 is usually composed of LED lamp beads, a wire, a controller, and the like, which can provide a uniform and soft lighting effect. The fixed connection between the decorative light strip 400 and the accommodating housing 100 is achieved through buckled connection. A purpose of the fixed connection is to ensure that the decorative light strip 400 remains stable during use of the light box and will not move or fall off due to an external force.
S42: sealing the decorative light strip 400 and the accommodating housing 100 with glue. After the decorative light strip 400 is fixedly connected to the accommodating housing 100, glue sealing treatment needs to be performed in order to improve the overall sealing and waterproof performance. The glue sealing treatment can be performed on a joint between the decorative light strip 400 and the accommodating housing 100 to form a glue tape for sealing, which prevents moisture, dust, and other pollutants from entering the light box. The glue sealing treatment can also enhance the connection strength between the decorative light strip 400 and the accommodating housing 100, which further improves a durability of the light box.

By performing step S41 and step S42, the fixed connection and the sealing treatment between the decorative light strip 400 and the accommodating housing 100 ensure the overall structural stability and sealing property of the light box, thus providing a reliable guarantee for normal work and long-term use of the light box.

In this embodiment, step S60 includes:
S41: fixedly connecting the bottom plate 200 to the accommodating housing 100; and
S42: sealing the bottom plate 200 and the accommodating housing 100 with glue.

In this embodiment, step S60 specifically includes the following steps:
S61: fixedly connecting the bottom plate 200 to the accommodating housing 100. Firstly, the bottom plate 200 is placed at a designated position of the accommodating housing 100. The bottom plate 200 is made of a black PVC material. A size of the bottom plate needs to be determined according to the design and structure of the light box. The fixed connection between the bottom plate 200 and the accommodating housing 100 is achieved through adhesive bonding. A purpose of the fixed connection is to ensure that the bottom plate 200 remains stable during use of the light box and will not move or fall off due to an external force.
S62: sealing the bottom plate 200 and the accommodating housing 100 with glue. After the bottom plate 200 is fixedly connected to the accommodating housing 100, glue sealing treatment needs to be performed in order to improve the overall sealing and waterproof performance. The glue sealing treatment can be performed on a joint between the bottom plate 200 and the accommodating housing 100 to form a glue tape for sealing, which prevents moisture, dust, and other pollutants from entering the light box. The glue sealing treatment can also enhance the connection strength between the bottom plate 200 and the accommodating housing 100, which further improves a durability of the light box.

By performing step S61 and step S62, the fixed connection and the sealing treatment between the bottom plate 200 and the accommodating housing 100 ensure the overall structural stability and sealing property of the light box, thus providing a reliable guarantee for normal work and long-term use of the light box.

As described above, one or more embodiments are provided in conjunction with the detailed description, The specific implementation of the present disclosure is not confirmed to be limited to that the description is similar to or similar to the method, the structure and the like of the present disclosure, or a plurality of technical deductions or substitutions are made on the premise of the conception of the present disclosure to be regarded as the protection of the present disclosure.

1. A light box, comprising:
an accommodating housing, wherein the accommodating housing is provided with a presentation panel, an accommodating chamber, and an opening communicated to the accommodating chamber, wherein the presentation panel comprises a preset hollow region and a clamping hole, and the preset hollow region is in a shape of a selected character;
a bottom plate, wherein the bottom plate is covered at the opening; the bottom plate comprises a bottom plate inner side and a bottom plate outer side corresponding to the bottom plate inner side; the bottom plate inner side is opposite to the opening;
a bottom plate light strip, wherein the bottom plate light strip is arranged on the bottom plate inner side to illuminate the accommodating chamber; and
a decorative light strip, wherein the decorative light strip is provided with a lamp bead assembly; and the lamp bead assembly penetrates through the presentation panel through the clamping hole from the accommodating chamber, and is fixedly connected to the presentation panel.

2. The light box according to claim 1, wherein the presentation panel is further provided with a hollow wireframe; and the hollow wireframe is arranged around the preset hollow region.

3. The light box according to claim 1, wherein the lamp bead assembly is provided with a base, a hemispherical housing, a light-emitting diode (LED) wick, and a control chip; the base is fixedly connected to the hemispherical housing; the base and the hemispherical housing jointly define a lamp bead space; the LED wick and the control chip are arranged in the lamp bead space; and the control chip is configured to control a lighting change of the LED wick.

4. The light box according to claim 3, wherein the base is provided with a clamping convex block; and the clamping convex block is in clamping connection to the clamping hole, so that the lamp bead assembly is connected to the presentation panel.

5. The light box according to claim 4, wherein a junction of the clamping connection between the clamping convex block and the clamping hole is sealed with glue.

6. The light box according to claim 1, further comprising a light-transmittance plate, wherein the light-transmittance plate is arranged in the accommodating chamber and abuts against the presentation panel; and the light-transmittance plate covers the preset hollow region.

7. The light box according to claim 1, wherein the accommodating housing is further provided with a mounting hole; and the mounting hole is gourd-shaped.

8. The light box according to claim 1, wherein the accommodating housing is further provided with a drain hole communicated to the accommodating chamber; and the drain hole is located in a bottom of the accommodating housing.

9. The light box according to claim 1, wherein a black coating layer is arranged on an outer surface of the accommodating housing; and the black coating layer is configured to reduce a light reflectivity of the outer surface of the accommodating housing.

10. The light box according to claim 9, wherein the accommodating housing is made of a metal material, and the black coating layer is a metal baking paint.

11. The light box according to claim 10, wherein the metal material is a stainless steel plate.

12. The light box according to claim 1, wherein the bottom plate and the accommodating housing are fixedly connected to close the opening.

13. The light box according to claim 6, wherein the light-transmittance plate is an acrylic plate.

14. The light box according to claim 1, wherein the bottom plate is a black polyvinyl chloride (PVC) plate.

15. A method for making a light box, comprising:
S10: measuring and scribing a metal plate;
S20: hollowing and bending the metal plate according the scribing;
S30: mounting a light-transmittance plate;
S40: mounting a decorative light strip;
S50: mounting a bottom plate light strip on a bottom plate; and
S60: mounting the bottom plate.

16. The method for making the light box according to claim 15, wherein step S20 comprises:
S21: cutting a leftover material of the metal plate;
S22: performing hollowing according to scribed shapes of a preset clamping hole, a preset character shape, and a preset wireframe;
S23: for a scribed line with a preset bend, first performing dadoing, forming a V-shaped opening by cutting, performing flanging bending, and welding a connected edge after the flanging bending, thus forming an accommodating housing; and
S24: grinding an outer surface of the accommodating housing, and performing baking paint treatment.

17. The method for making the light box according to claim 16, wherein step S24 of performing baking paint treatment comprises:
S24a: performing preliminary baking paint treatment; and
S24b: performing secondary baking paint treatment.

18. The method for making the light box according to claim 16, wherein step S30 comprises:
S31: fixedly connecting the light-transmittance plate to the accommodating housing; and
S32: sealing the light-transmittance plate and the accommodating housing with glue.

19. The method for making the light box according to claim 16, wherein step S40 comprises:
S41: fixedly connecting the decorative light strip to the accommodating chamber; and
S42: sealing the decorative light strip and the accommodating housing with glue.

20. The method for making the light box according to claim 16, wherein step S60 comprises:
S61: fixedly connecting the bottom plate to the accommodating housing; and
S62: sealing the bottom plate and the accommodating housing with glue.
